(19) United States
(12) Patent Application Publication
(10) Pub. No.: US 2008/0040655 A1
(43) Pub. Date: Feb. 14, 2008

(54) Table data processing method and apparatus

(75) Inventor: Hiroshi Tanaka, Kawasaki (JP)

Correspondence Address: Patrick G. Burns;GREER, BURNS & CRAIN, LTD., 300 South Wacker Drive, Suite 2500, Chicago, IL, 60606, US

(73) Assignee: FUJITSU LIMITED

(21) Appl. No.: 11/639,167

(22) Filed: Dec. 13, 2006

(30) Foreign Application Priority Data
Aug. 14, 2006 (JP) 2006-221118

(51) Int. Cl. G06F 17/00; G06K 9/34

(52) U.S. Cl. 715/228; 715/227; 382/175

(57) ABSTRACT

This invention is a support technique for enabling the easy correction of the ruled lines and cells, which are automatically extracted from the form document image or the like. This invention includes: generating plural candidate cells from an image of a table including plural cells, and outputting an initial table by extracting a specific combination of the candidate cells; accepting, as designation of an error cell, designation of a specific candidate cell included in the initial table from a user; generating a candidate group by selecting the candidate cell that can replace at least a portion of the designated error cell, from the candidate cells other than the specific combination of the candidate cells; and presenting the candidate group for the user, and prompting the user to select one of the candidate cells included in the candidate group.

### TECHNICAL FIELD OF THE INVENTION

This invention relates to a technique to recognize a table that is composed of ruled lines and cells, which are areas surrounded by the ruled lines, from an image of the table, more specifically to a technique to correct the automatically recognized ruled lines or cells.

### BACKGROUND OF THE INVENTION

Recently, a lot of electronic documents have come to be used along with the computerization of the business. As a technique for computering the business, which has been operated with paper documents, or for converting documents distributed with the papers into electronic documents, the importance of a document image recognition technique such as an optical character reader or optical character recognition (OCR) increases. Especially, a technique for recognizing a table included in the documents such as form documents is important.

The table is used to be composed of vertical and horizontal ruled lines. In a table recognition technique to recognize the structure of the table, a technique to recognize the ruled lines in the table, and the position and the size of the cells surrounded by the ruled lines has been developed.

The ruled line extraction method includes a method for extracting ruled lines based on vertical and horizontal runs of pixels in the document image, for example (e.g. JP-A-H1-217583). Image input means obtains a document image by a scanner or the like. Vertical and horizontal run extraction means extracts areas in which black pixels continue by a predetermined length or more in a vertical direction or a horizontal direction, as run areas. Vertical and horizontal run unification means unifies the extracted run areas adjacent to each other into one ruled line area. Finally, the extracted ruled line areas are stored into a ruled line data structure.

In addition, JP-A-H7-28939 discloses a technique for enabling to correctly vectorize a table portion even if an input image is somewhat inclined. Specifically, in an apparatus for vectoring the table portion from an table image, a projection unit is provided in which segments are categorized into a vertical direction group and a horizontal direction group from the table image, only segments in the vertical direction group are projected to a horizontal axis, and only segments in the horizontal direction group are projected to a vertical axis to obtain a projection image of the ruled lines. In addition, a mask image generator for drawing a straight line having the same width as the projection image of the ruled line on a memory from the vertical direction/horizontal direction to generate a mask image, and a ruled line retrieving unit for retrieving ruled lines according to the mask image to vectorize the table portion are provided. Then, the ruled line retrieving unit extracts intersections of the straight lines from the mask image, and determines the existence of the ruled line between the intersections from a ratio of the number of pixels to the distance between the extracted intersections.

The cell extraction method mainly includes a method for extracting rectangular areas surrounded by the ruled lines, and a method for extracting intersections that are points the ruled lines cross, and extracting cell areas based on the position relation of the intersections. The method for extracting rectangular areas surrounded by the ruled lines is disclosed in, for example, “A Study on Table Recognition with Complex Structure”, Kojima, Kiyosue, Akiyama, 37th second half of the national convention in Information processing Society of Japan, 6W-8, pp. 1660-1161 (1988.10) (hereinafter, called non-patent document 1), and “Structure Recognition of Various Kinds of Table-Form Documents”, Qin, Watanabe, Sugie, the Transactions of the Institute of Electronics, Information and Communication Engieers, D-II, Vol. J76-D-II, No. 10, pp. 2165-2176 (1993.10) (hereinafter, called non-patent document 2). Furthermore, JP-A-H9-50527 also uses the similar principle.

The cell extraction method by the non-patent document 2 is as follows: That is, an area of a table for which the cell extraction is carried out is determined as a target area, and the target area is divided by a horizontal ruled line that reaches from an edge to another edge of the target area. Then, the target area is vertically divided for each divided area. Similarly, the horizontal division and vertical division are carried out in turn, and these divisions are repeated until the division becomes impossible. Then, the cells are extracted.

In addition, the method for extracting the cell areas based on the intersections the ruled lines cross is disclosed in various documents. For example, JP-A-H8-212292, JP-A-H9-138837, JP-A-H10-40333 and JP-A-H8-221506 disclose the method. The basic procedure is: tracing the cell inside clockwise from a left upper of the cell as a start point, and identifying a route to the start point as a cell area.

There is a case where the ruled lines and the cells extracted by the aforementioned table recognition technique are incorrect. Especially, it is considered that a lot of errors exist when the table is recognized from the deteriorated image. Then, by an approach to reduce the errors by improving the accuracy of the table recognition and an approach to improve the operability for the error correction by the user, an attempt to reduce the bad influence by the incorrect table recognition is carried out.

As one attempt to reduce the errors, a method is proposed in which the extraction results of the ruled lines and cells are not fixed, plural candidates are generated, and finally, an optimum set of candidates are selected. For example, “A Cell Extraction Method for Form Documents based on Combinatorial Optimization”, Tanaka, Takebe, and Fujimoto, Technical Research Report of the Institute of Electronisc, Information and Communication Engineers, PRMU2005-185, (2006.2) (hereinafter, called non-patent document 3) discloses a following technique. That is, plural candidates of cell areas is extracted by using information of intersections at which the table ruled lines are intersected, and an optimum set of cells is obtained by combination searching. In this technique, by preparing plural candidates for ambiguous intersections, and generating plural cell candidates, the influence reduction of the intersection errors are realized.

On the other hand, as for the method for correcting the error ruled line and cell by the user, a method was conventionally used in which an error portion is deleted, and the user separately inputs the correct ruled line or cell, or a shape of the error ruled line or cell is changed by the user operation to generate the correct result. For example, the user designates an error cell 1000 by using a cursor 101 (See FIG. 24A), deletes it (See FIG. 24B), and then draws ruled lines and/or cells for a lacked portion by himself or herself (See FIGS. 24C and 24D). In addition, when plural cells should be drawn, a lot of trouble for the correction is necessary. Such an edit operation includes some operations such as deletion and insertion of the cell and/or ruled line and change of the shape.

In addition, JP-A-H6-60222 discloses a following technique. That is, from input image data relating to a business form, a separator candidate is extracted, and information of the separator candidate and the input image data are displayed. Then, based on a screen displaying the image data at least one operation of correction/addition/selection for the separator candidate is executed by a user using a keyboard or the like, and then separator candidate information finally fixed by this execution is registered in a format database. This enables addition of information if necessary, in addition to preventing from mistakes of registration of the separator information registered in the database and lack of information. In addition, after that, when the business form is recognized, by referring to the separator information registered in the format database, it is possible to easily recognize characters, and to enhance the recognition accuracy. However, this does not have a configuration in which the candidate of the cell and ruled line is presented to select one.

Furthermore, JP-A-H8-153161 discloses a document image recognition apparatus having a document image input unit for inputting a document as quantization image data; a document image storage for storing the document image inputted from the document image input unit; a layout analyzer for performing diagram separation, table analysis, column setting separation, segment separation, line separation, and character separation for the document image to extract layout information; a layout error candidate detector for identifying parts having high possibility of a table item separation error by suing a shape of an outline of the ruled lines, which constitute the table item, from among the layout information obtained in the layout analyzer, identifying a segment separation error by verifying character pitch and character width, identifying a line separation error by verifying line pitch and line width, and respectively adding a layout error flag representing the type of the error; a layout information storage that stores the layout information with the layout error flag; a character recognition unit for recognizing a character image obtained in the layout analyzer to obtain character codes; a character information storage that stores character codes obtained in the character recognition unit; a correction instruction input unit for inputting an operation from the user; a correction processor that stores, in advance, an area division direction and the number of area divisions as a layout candidate with respect to a table item separation error, a direction of a segment as a layout candidate with respect to a segment separation error, and a direction of the character string as a layout candidate with respect to a line separation error, inputting respective outputs of the layout information storage, document image storage and character information storage, outputting as display information, the layout candidate corresponding to the layout error flag, the document image and the character codes, selecting a correct layout candidate from among the layout candidates according to the output of the correction instruction input unit to output it, as reanalysis information, and correcting the character code having an error according to the output of the correction instruction unit; a reanalysis controller that makes the layout analyzer activate a reexecution of a layout analysis processing based on the reanalysis information designated by the correction processor; and an image display unit that displays display information outputted by the correction processor. However, an interface enabling the intuitive selection of the cell shape is not disclosed.

In addition, JP-A-2001-118030 discloses a technique for simplifying the item name definition work of the form and shortening the time required for the work. Specifically, plural variable item fields constituting the format of a document are extracted from an image of the document, the extracted variable item fields are displayed to an operator to make him or her designate one variable item field. Then, a candidate for a fixed item field in a specific relation with the variable item field is extracted by using features in the image, and the extracted fixed item fields are displayed to the operator to make him or her to designate one or more fixed item fields. The association information of the variable item field and fixed item fields is stored and used to edit format data. Consequently, item names can easily be defined in a short time and this technique is adaptive even when one area or variable item field has plural item names. This publication does not disclose any interface enabling the intuitive selection of the shape of the cell.

Furthermore, JP-A-2001-109888 discloses a ruled line extraction technique for enabling a ruled line extraction processing adaptive to the quality of an image. Specifically, image input means obtains an input image and different resolution image generating means generates a low-resolution image and a high-resolution image. Ruled-line candidate area extracting means extracts a ruled-line candidate area by using the generated low-resolution image. Image quality evaluating means searches the pixels in the extracted ruled-line candidate area to evaluate the quality of the image and means that selects a processing method or threshold according to the quality selects a processing method or threshold, which matches the image quality according to the result of the evaluation by the image quality evaluating means. Means for selecting appropriate image resolution for each partial processing selects an image to be processed according to the image quality. Through the aforementioned means, the proper processing method, threshold, and image to be processed for the ruled-line extracting means are selected to extract the ruled lines. This publication does not disclose any interface enabling the intuitive selection of the shape of the cell, too.

In addition, JP-A-H11-219442 discloses a document edit output apparatus for changing an output image according to filled content for a form and editing and outputting it. Specifically, the apparatus has document structure analyzing means for analyzing the structure of a document by collating a document image with a document layout rule; document layout rule storing means for storing the document layout rule; input image data storing means for storing partial document images obtained by the analysis of the document structure; image information coding means for coding a partial document image whose coding within the partial document image is possible, in accordance with the document layout rule; output rule storing means for storing an output rule for determining the contents of an output image in accordance with the code information obtained by the image information coding means and the contents of the partial document images stored in the input image data storing means; output information determining means for determining the output contents by using the output rule; and editing and outputting means for inputting the document contents outputted from the output information determining means to generate an output image. This publication does not disclose any interface enabling the intuitive selection of the shape of the cell, too.

As described above, in a case where the result of the automatic extraction of the ruled lines and cells by a form design support apparatus that carries out design of the form format based on the ruled lines and cells, which are extracted from a form document image, has errors, it is necessary to carry out edit operations such as designating the incorrect portion by the user to delete it, and drawing again or changing. Such an error correction by the edit operations may require the drawing two or more time, and the user must carefully identify the precise coordinate position. Therefore, it is a large burden for the user.

### SUMMARY OF THE INVENTION

Therefore, an object of this invention to provide a support technique for enabling the easy correction of the ruled lines or cells, which are automatically extracted from the form document image or the like.

Furthermore, another object of this invention is to provide a technique to reduce the work load when correcting the ruled lines or cells, which are automatically extracted from the form document image or the like.

A table data processing method according to a first aspect of this invention includes: generating a plurality of candidate cells from an image of a table including a plurality of cells, and outputting an initial table by extracting a specific combination of the candidate cells; accepting, as designation of an error cell, designation of a specific candidate cell included in the initial table on the initial table from a user; generating a candidate group by selecting the candidate cell that can replace at least a portion of the designated error cell from the candidate cells other than the specific combination of the candidate cells, and storing data of the candidate group into a storage device; and presenting the candidate group stored in the storage device for the user, and prompting the user to select one of the candidate cells included in the candidate group.

According to this aspect of this invention, the user only has to select one of the candidate cells included in the candidate group. Therefore, the correction becomes easy. In addition, the drawing while troubling the user to pay attention to the coordinates becomes unnecessary, and the work load for the correction can be omitted. Moreover, the business efficiency can be improved.

In addition, the table data processing method according to the first aspect of this invention may further include: identifying, for each candidate cell included in the candidate group, an associated candidate cell to be simultaneously selected with the candidate cell included in the candidate group. In such a case, the aforementioned presenting and prompting may include: presenting the candidate cell included in the candidate group and the associated candidate cell of the candidate cell. By these steps, the correction becomes much easier.

Furthermore, the table data processing method according to the first aspect of this invention may further include: accepting, as selection of a next candidate cell, selection of one candidate cell included in the candidate group from the user; identifying a third candidate cell to be selected next to the selected next candidate cell, and storing data of the third candidate cell into the storage device; and presenting the third candidate cell stored in the storage device for the user. As described above, when the correction can be carried out consecutively, it becomes possible to reduce the work load.

Moreover, the aforementioned identifying the associated candidate cell may include: identifying, for each candidate cell included in the candidate group, a non-overlapped portion that is a portion of the error cell, and which the candidate cell does not cover; and identifying, for each candidate cell included in the candidate group, a candidate cell including the non-overlapped portion, other than the specific combination of the candidate cells, as the associated candidate cell.

Furthermore, the aforementioned identifying the third candidate cell may include: selecting, as a quasi-error cell, a blank in the initial table, which is caused by adopting the selected next candidate cell and excluding the error cell; and executing the aforementioned generating the candidate group and the subsequent processing by treating the quasi-error cell as the error cell.

Furthermore, the aforementioned table may be divided into lattice blocks, wherein the lattice block is a minimum unit of the candidate cell. In such a case, for each of the plurality of candidate cells, identification data of the lattice block constituting the candidate cell, and data representing whether or not the candidate cell is a cell constituting the table may be stored in the lattice data storage. Then, the aforementioned generating the candidate group may include: identifying the lattice block constituting the designated error cell from the lattice data storage; and referring to the lattice data storage to extract the candidate cell including the identified lattice block from the candidate cells other than the specific combination of the candidate cells. By introducing the lattice block, the processing is simplified and the speed of the processing is enhanced.

In addition, in a case of introducing the lattice block and the lattice data storage, the aforementioned identifying the associated candidate cell may include: comparing the lattice blocks constituting the candidate cell, which are identified from the lattice data storage, with the lattice blocks constituting the error cell to identify, for each candidate cell included in the candidate group, a non-overlapped lattice block that is a lattice block included in the error cell and in which the candidate cell does not cover the error cell; and identifying, for each candidate cell included in the candidate group, the candidate cell including the non-overlapped lattice block other than the specific combination of the candidate cells from the lattice data storage as the associated candidate cell.

Furthermore, in the case of introducing the lattice block and the lattice data storage, the aforementioned generating the candidate group may include: registering data so as to exclude the designated error cell from the cells constituting the table, for the designated error cell in the lattice data storage; identifying, from the lattice data storage, the lattice blocks constituting the designated error cell; and extracting, as the candidate cell included in the candidate group, the candidate cell including the identified lattice block from the candidate cells that are registered in the lattice data storage as not being the cells constituting the table, except the error cell. In addition, the aforementioned identifying the third candidate cell may include: registering, as the cell constituting the table, the selected next candidate cell in the lattice data storage; identifying the candidate cell including the lattice block constituting the error cell among the candidate cells that are registered as the cells constituting the table in the lattice data storage, except the selected next candidate cell, and registering data so as to exclude the identified candidate cell from the cells constituting the table; identifying, as the quasi-error cell, the lattice block that is not adopted for any of the candidate cells registered as the cells constituting the table in the lattice data storage; and executing the aforementioned generating the candidate group and the subsequent processing by treating the quasi-error cell as the error cell.

Although the aforementioned first aspect of the invention relates to the cell, this invention can be applied to the ruled line. That is, a table data processing method according to a second aspect of this invention includes: generating a plurality of candidate ruled lines from an image of a table including a plurality of ruled lines, and outputting an initial table by extracting a specific combination of the candidate ruled lines; accepting, as designation of an error cell, designation of a specific candidate ruled lines included in the initial table on the initial table from a user; generating a candidate group by selecting the candidate ruled line that can replace at least a portion of the designated error ruled line from the candidate ruled lines other than the specific combination of the candidate ruled lines, and storing data of the candidate group into a storage device; and presenting the candidate group stored in the storage device for the user, and prompt the user to select one of the candidate ruled lines included in the candidate group.

Incidentally, it is possible to create a program for causing a computer to execute this method according to the present invention. The program is stored into a storage medium or a storage device such as, for example, a flexible disk, a CD-ROM, a magneto-optical disk, a semiconductor memory, or a hard disk. In addition, the program may be distributed as digital signals over a network in some cases. Data under processing is temporarily stored in the storage device such as a computer memory.

### BRIEF DESCRIPTION OF THE DRAWINGS

FIG. 1 is a functional block diagram of a form design support apparatus in an embodiment of this invention;

FIG. 2 is a diagram showing a main processing flow in the embodiment of this invention;

FIGS. 3A to 3F are diagrams to explain a preprocessing of the main processing flow;

FIG. 4 is a diagram showing an example of data stored in a lattice data storage;

FIG. 5 is a diagram showing an example of data stored in a lattice table;

FIG. 6 is a diagram showing a processing of a first candidate cell correction processing by a next candidate generator;

FIG. 7 is a diagram showing an example of an input image;

FIG. 8 is a diagram to explain the lattice block and index;

FIG. 9 is a diagram showing an example of data stored in the lattice table;

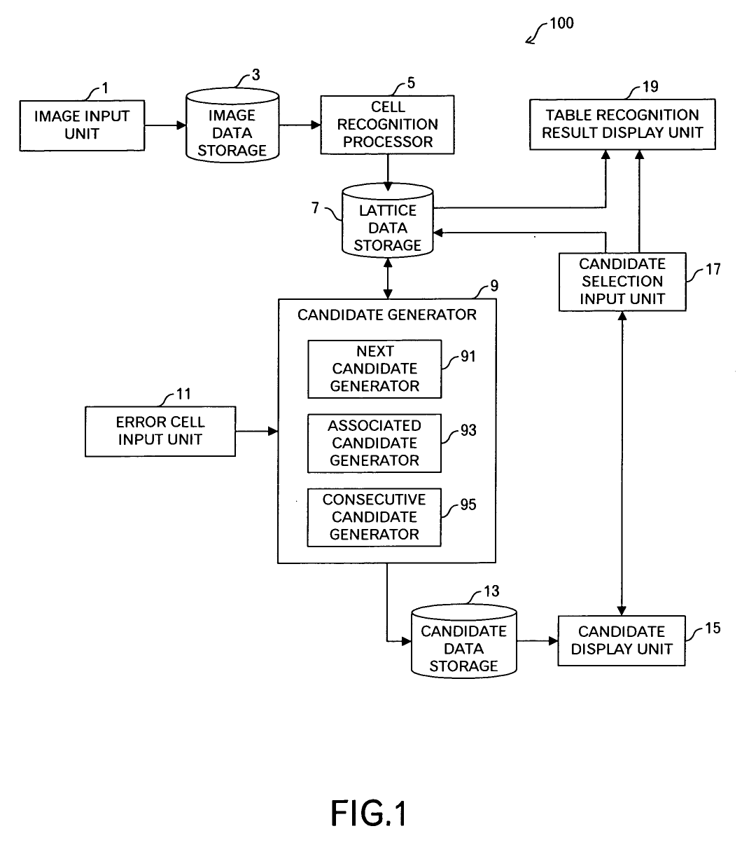

FIGS. 1A and 10B are diagrams to explain an outline of the first candidate cell correction processing;

FIGS. 11A and 11B are diagram showing a screen example in the first candidate cell correction processing;

FIG. 12 is a diagram showing a processing flow of a next candidate cell identifying processing;

FIG. 13 is a diagram showing a processing flow of a second candidate cell correction processing by an associated candidate generator;

FIGS. 14A and 14B are diagrams to explain an outline of the second candidate cell correction processing;

FIG. 15 is a diagram showing a processing flow of the second candidate cell correction processing by an associated candidate generator;

FIGS. 16A and 16B are diagrams showing a screen example in the second candidate cell correction processing;

FIG. 17 is a diagram showing a processing flow of a third candidate cell correction processing by a consecutive candidate generator;

FIGS. 18A to 18E are diagrams showing an outline of a processing using the consecutive candidate generator;

FIG. 19 is a diagram showing a processing of the third candidate cell correction processing by the consecutive candidate generator;

FIG. 20 is a diagram showing another example of data stored in the lattice table;

FIG. 21 is a diagram showing an example of a lattice table in a case of the ruled line;

FIGS. 22A to 22C are diagrams to explain an outline of a processing in a case of the ruled line;

FIG. 23 is a functional block diagram of a computer; and

FIGS. 24A to 24D are diagram to explain a conventional art.

### DETAILED DESCRIPTION OF THE PREFERRED EMBODIMENTS

FIG. 1 shows a functional block diagram for a form design support apparatus according to an embodiment of this invention. This form design support apparatus 100 in this embodiment has an image input unit 1 that is a device such as a scanner that optically reads the document including a table and the like; an image data storage 3 to store the image data read by the image input unit 1; a cell recognition processor 5 that carries out a processing to automatically recognize cells constituting a table from the read image data; a lattice data storage 7 to store data such as a lattice table generated by the cell recognition processor 5; a table recognition result display unit 19 to display the recognition result on a display device by using the data stored in the lattice data storage 7; an error cell input unit 11 to accept designation of the error cell by the user for the candidate cells included in the recognition result displayed by the table recognition result display unit 19; a candidate generator 9 that carries out a processing to identify the candidate cell to be presented for the user by using the data stored in the lattice data storage 7; a candidate data storage 13 to store data of the candidate cell identified by the candidate generator 9 and the like; a candidate display unit 15 that displays on the display device, the candidate cells to be presented for the user by using the data stored in the candidate data storage 13 and the like; and a candidate selection input unit 17 that accepts the candidate selection input by the user, updates the data stored in the lattice data storage 7 and cooperates with the candidate display unit 15 and/or the table recognition display unit 19.

The candidate generator 9 includes at least one of a next candidate generator 91, an associated candidate generator 93 and a consecutive candidate generator 95.

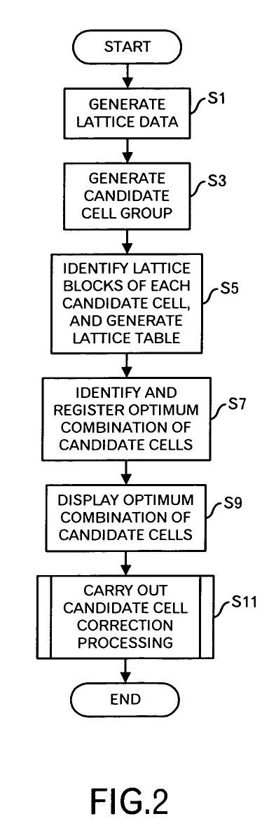

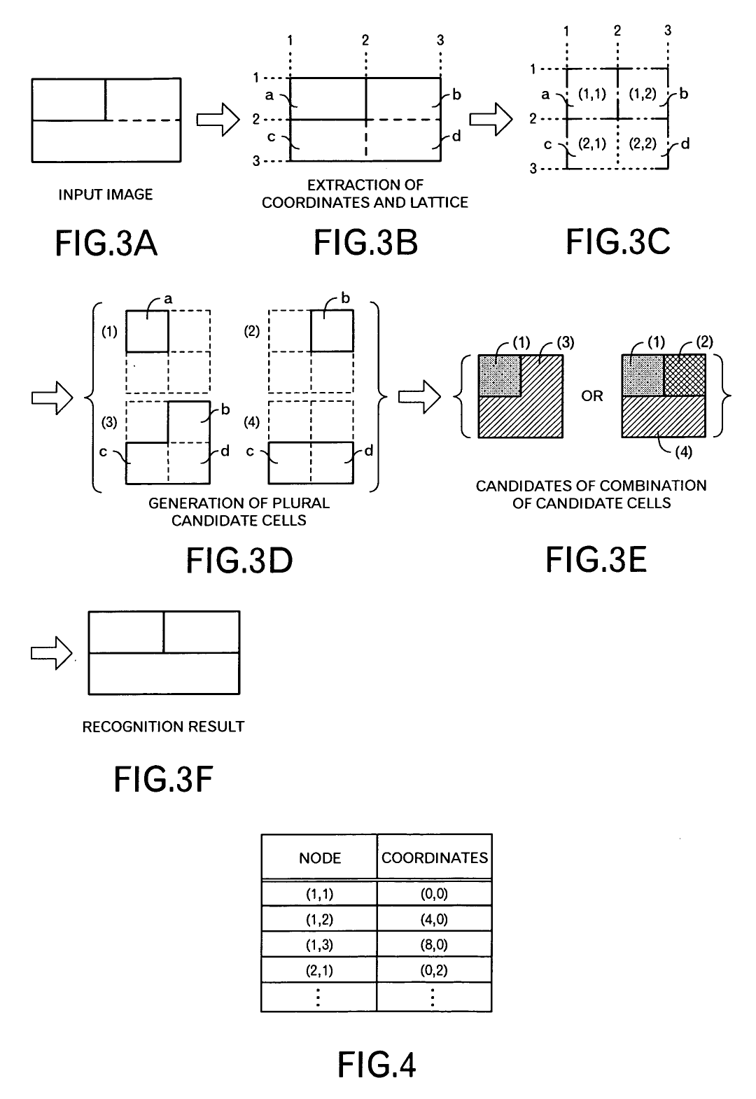

Next, a processing of the form design support apparatus 100 shown in FIG. 1 will be explained by using FIGS. 2 to 22. First, the image input unit 1 optically reads a form document including a table and the like, generates an image including the form document, and stores it into the image data storage 3. It is possible to obtain a file of the image including the form document from other storage devices, and obtain it from other computers via a network. For example, it is assumed that the image as shown in FIG. 3A is obtained. Incidentally, a portion displayed by a dotted line in FIG. 3A represents a portion where it is vague whether or not a ruled line exists (a portion where only a half or less is remained, because the ruled line is obscure, for example, and the like).

Next, the cell recognition processor 5 generates lattice data from the image data stored in the image data storage 3 according to an algorithm disclosed in the non-patent document 3, for example (or Japanese Patent Application 2006-31581), and stores the lattice data into the lattice data storage 7 (step S1). Specifically, the vertical and horizontal ruled lines constituting the table are extracted, and as shown in FIG. 3B, coordinates of lattice points (intersections and points to which the intersections, which exist on the ruled lines in the same direction, for example, are mapped) of each ruled line are identified, and an identifier is assigned to each lattice point. The coordinates are coordinates in a case where a predetermined point (e.g. an upper left lattice point) is the origin. As for the identifier of the lattice point, “1” is assigned to the upper left lattice point, for example, and the number is sequentially assigned to the lattice point in the vertical direction, and the number is sequentially assigned to the lattice point in the horizontal direction. Then, data as shown in FIG. 4 is stored in the lattice data storage 7, for example. That is, the coordinate values are stored for each lattice point.

Incidentally, in the subsequent processing, even if there is no information about the length of the ruled line, the coordinates of the lattice point can be obtained from the table shown in FIG. 4. Therefore, a condition where the vertical and horizontal lengths of each cell are identical each other as shown in FIG. 3C can be assumed. In addition, in FIGS. 3B and 3C, a minimum candidate cell, which may constitute the cell, is called a lattice block. In FIGS. 3B and 3C, the lattice blocks a to d exist. Furthermore, for example, as shown in FIG. 3C, based on the coordinate values, a lattice index (1,1) is assigned to a lattice block a, a lattice index (1,2) is assigned to a lattice block b, a lattice index (2,1) is assigned to a lattice block c, and a lattice index (2,2) is assigned to a lattice block d. By using the lattice blocks, it is possible to suppress a processing of comparing the coordinates and the like to the minimum, and the processing can be simplified and its speed can be improved.

Next, the cell recognition processor 5 generates a candidate cell group according to the aforementioned algorithm (step S3). For example, based on probability of the ruled line, in an example of FIG. 3D, a candidate cell (1), which is composed of the lattice block a, a candidate cell (2), which is composed of the lattice block b, a candidate cell (3), which is composed of the lattice blocks b to d, and a candidate cell (4), which is composed of the lattice blocks c and d are identified. However, at this stage, it is assumed that the candidate cells are identified from the ruled lines and the like, and the relation between the candidate cell and the lattice block has not been identified.

Then, the cell recognition processor 5 identifies the lattice blocks constituting each candidate cell, and generates the lattice table to store it into the lattice data storage 7 (step S5). Specifically, the following processing is carried out: comparing vertex coordinates of each candidate cell with the coordinates (FIG. 4) of the lattice point, which are stored in the lattice data storage 7; associating each vertex of each candidate cell with a nearest lattice point; identifying, based on the association of the vertex of the cell and the lattice point, the lattice blocks included in each candidate cell; and registering the identified lattice blocks.

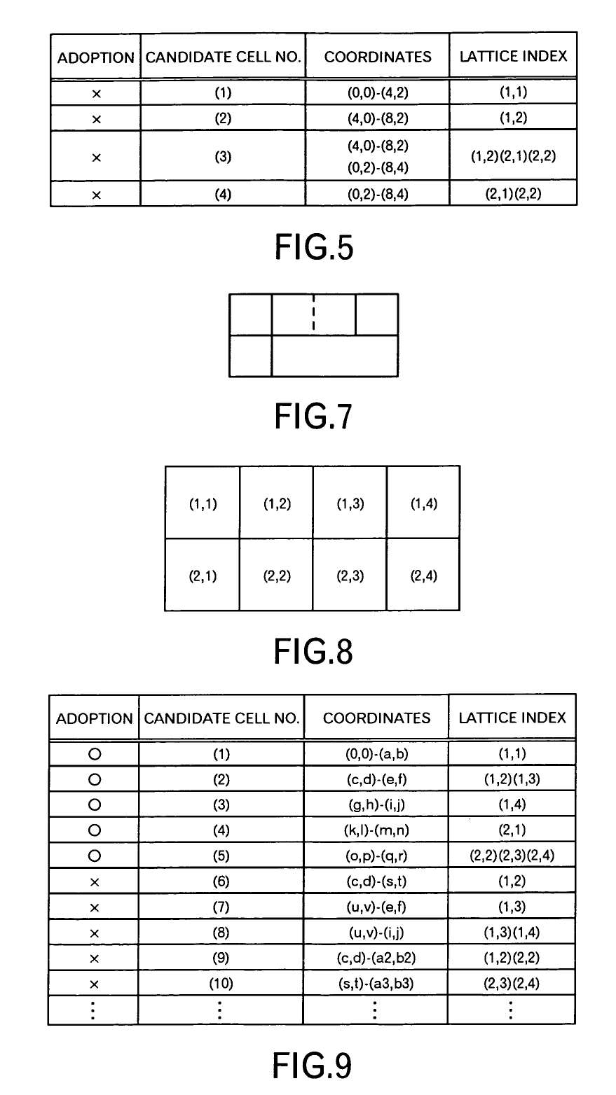

For example, the lattice table as shown in FIG. 5 is stored in the lattice data storage 7. In the example of FIG. 5, the lattice table includes a column of an adoption flag representing whether or not the candidate cell is adopted, a column of a candidate cell number, a column of coordinates of the candidate cell, a column of a lattice index constituting the candidate cell. At this stage, “off” is set to all of the adoption flags. As for the coordinates, the coordinates of the upper left vertex (or lattice point) and the coordinates of the lower right vertex (or lattice point) are basically registered. In a case of the candidate cell (3), it is possible to register the coordinates of the upper left vertexes and the lower right vertexes of the two divided areas or the coordinates of all the vertexes.

Furthermore, the cell recognition processor 5 extracts candidates of combinations of the candidate cells to complete the table according to the algorithm, identifies the optimum combination of the candidate cells, which is the most probable, among the extracted candidates of the combinations, and registers the identified optimum combination of the candidate cells into the lattice table in the lattice data storage 7 (step S7). In the example of FIG. 3E, a combination of the candidate cells (1) and (3), and a combination of the candidate cells (1), (2) and (4) are extracted as candidates. Then, the right side of FIG. 3E is identified, as the most probable candidate, among these combination. Then, in the lattice table in the lattice data storage 7, “on” is set to the adoption flags for the candidate cells (1), (2) and (4). In the example of FIG. 5, “on” is set to the adoption flags for the first, second and fourth lines.

Then, the table recognition result display unit 19 uses the data of the lattice table stored in the lattice data storage 7 to display, as the table recognition result, the optimum combination of the candidate cells (step S9). For example, the display as shown in FIG. 3F is carried out.

Then, when a predetermined key or a predetermined button displayed on a display screen or the like is pushed by the user, a candidate cell correction processing is carried out (step S11). For example, in a case where the table as shown in FIG. 3F is displayed, when the user selects one of the candidate cells as the error cell, the step S11 may be carried out.

As for the processing of the step S11, because the processing using the next candidate generator 91, the processing using the associated candidate generator 93 and the processing using the consecutive candidate generator 95 are different each other, the respective processings will be explained.

### (1) In Case of the Next Candidate Generator 91

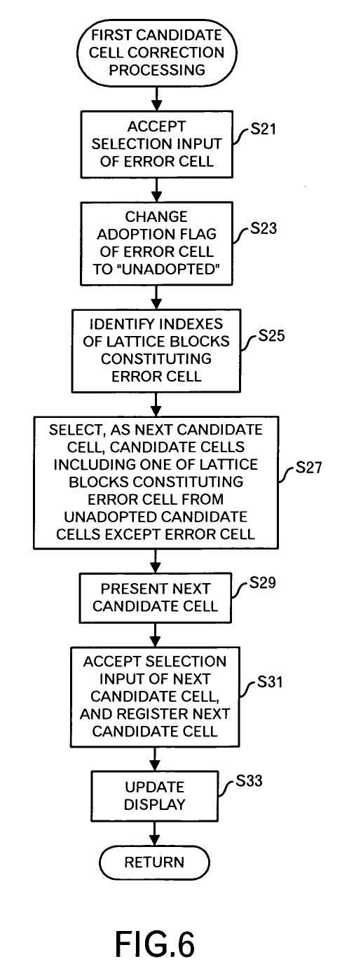

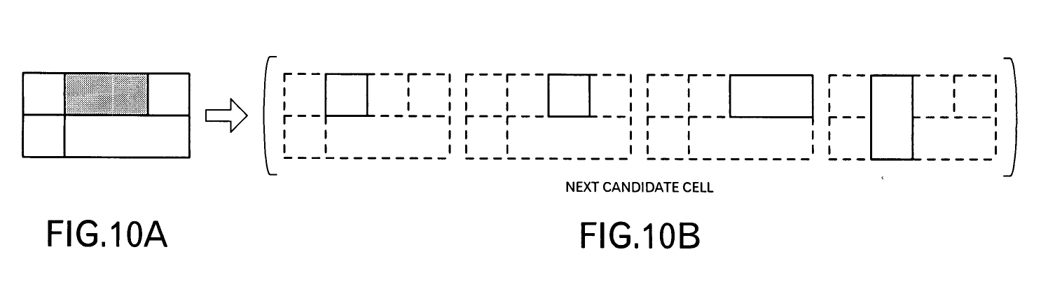

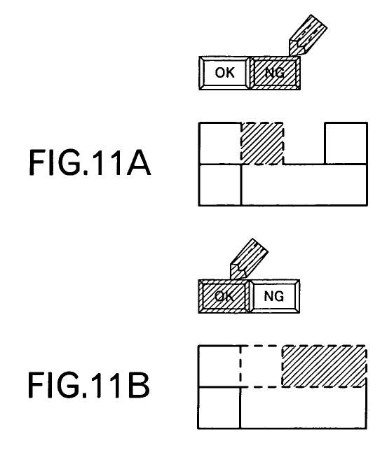

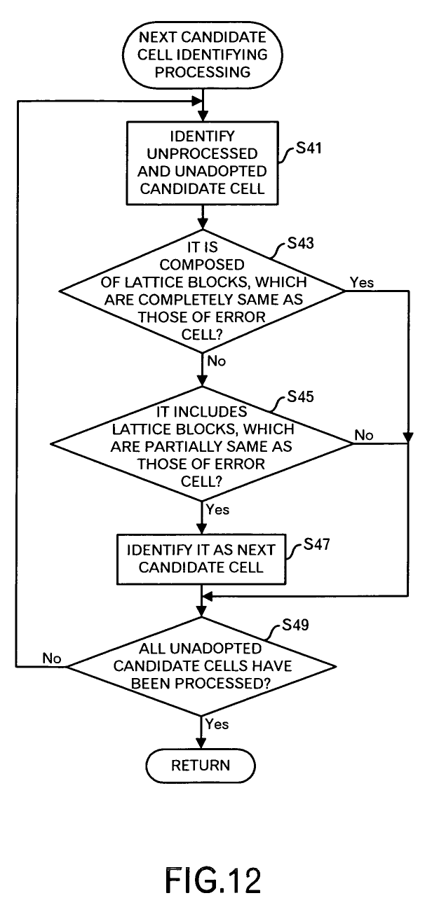

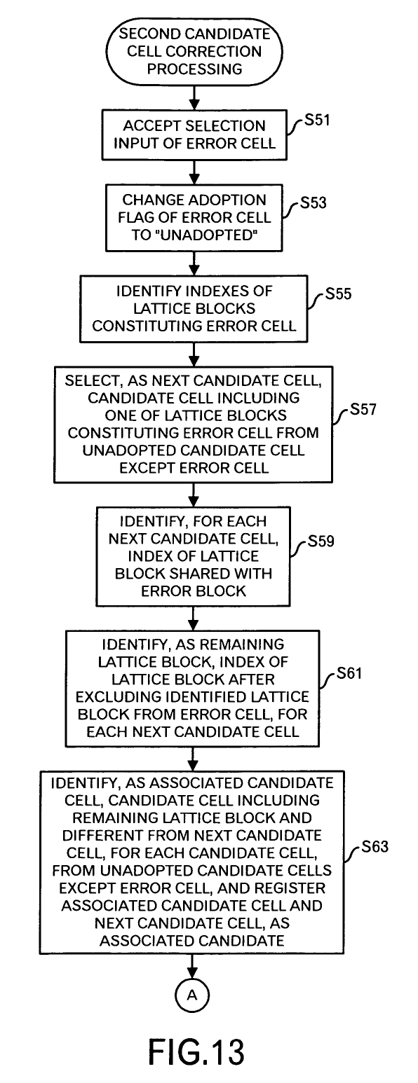

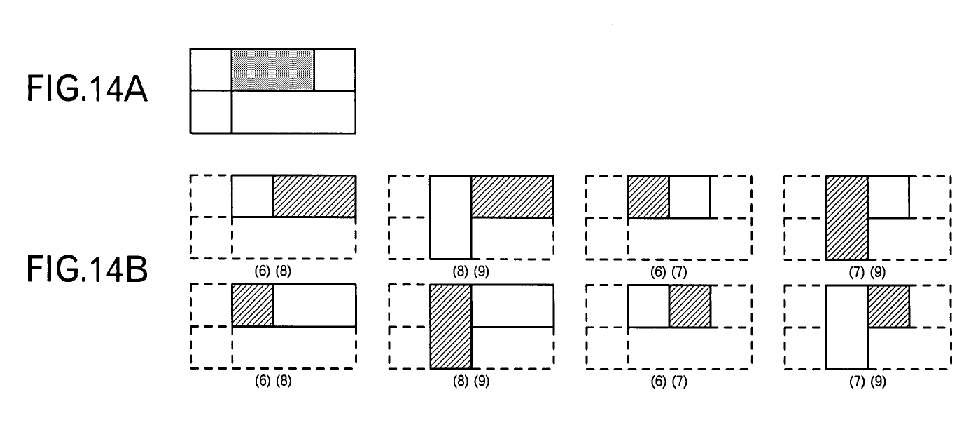

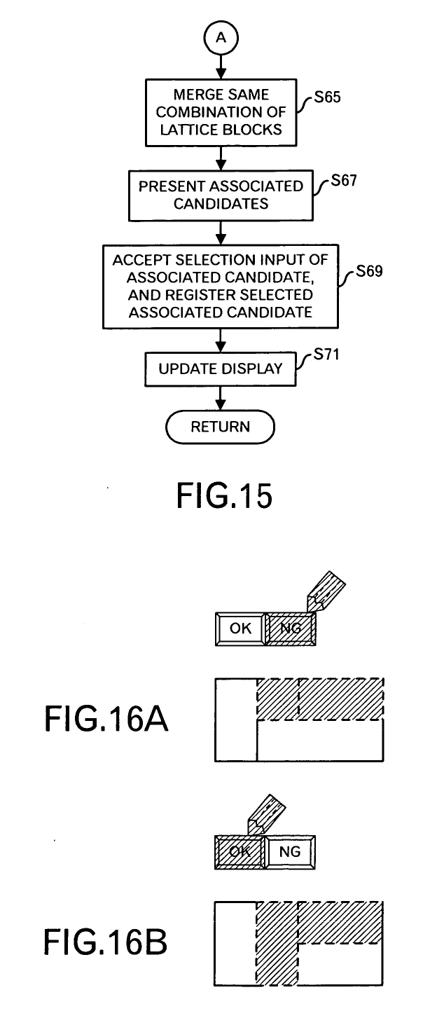

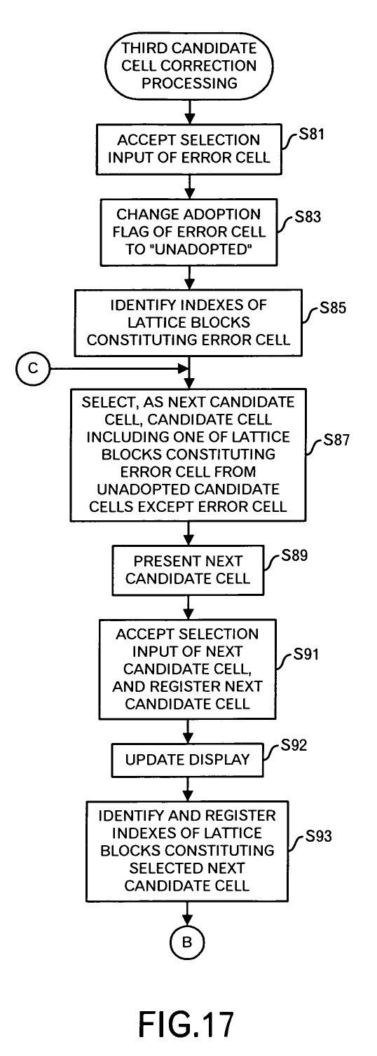

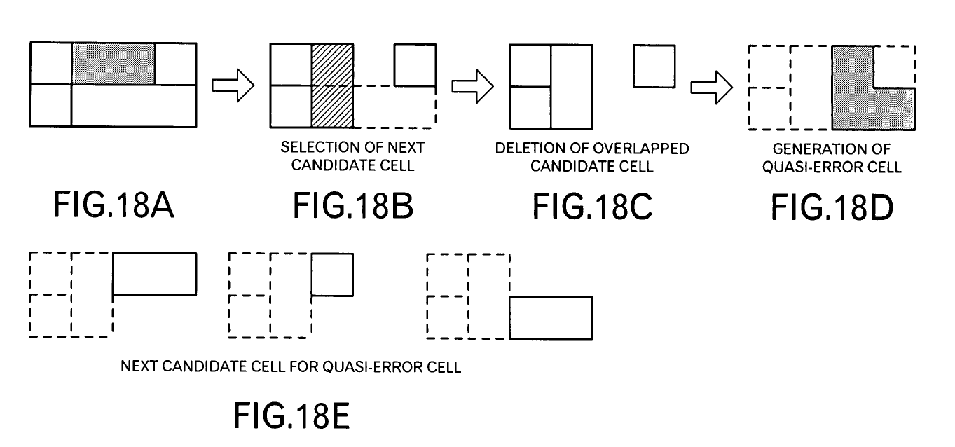

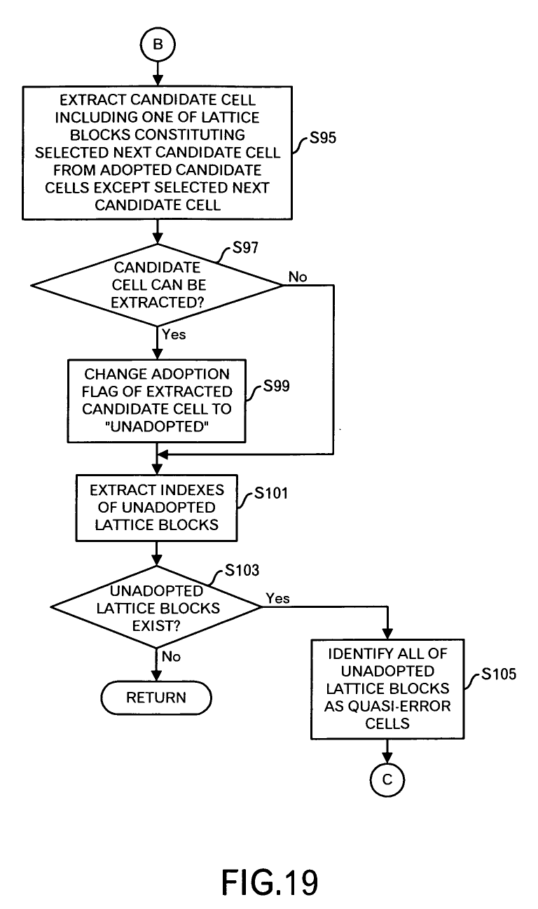

The processing using the next candidate generator 91 will be explained by using FIGS. 6 to 12. The user watches the initial table displayed on the display device as the recognition result to confirm whether or not the recognition error exists. Then, when the recognition error exists, the user uses an input device (e.g. mouse or pen) to designate a cell relating to the recognition error. The error cell input unit 11 of the form design support apparatus 100 accepts the selection input of the error cell from the user (step S21), and outputs data of the error cell to the candidate generator 9.

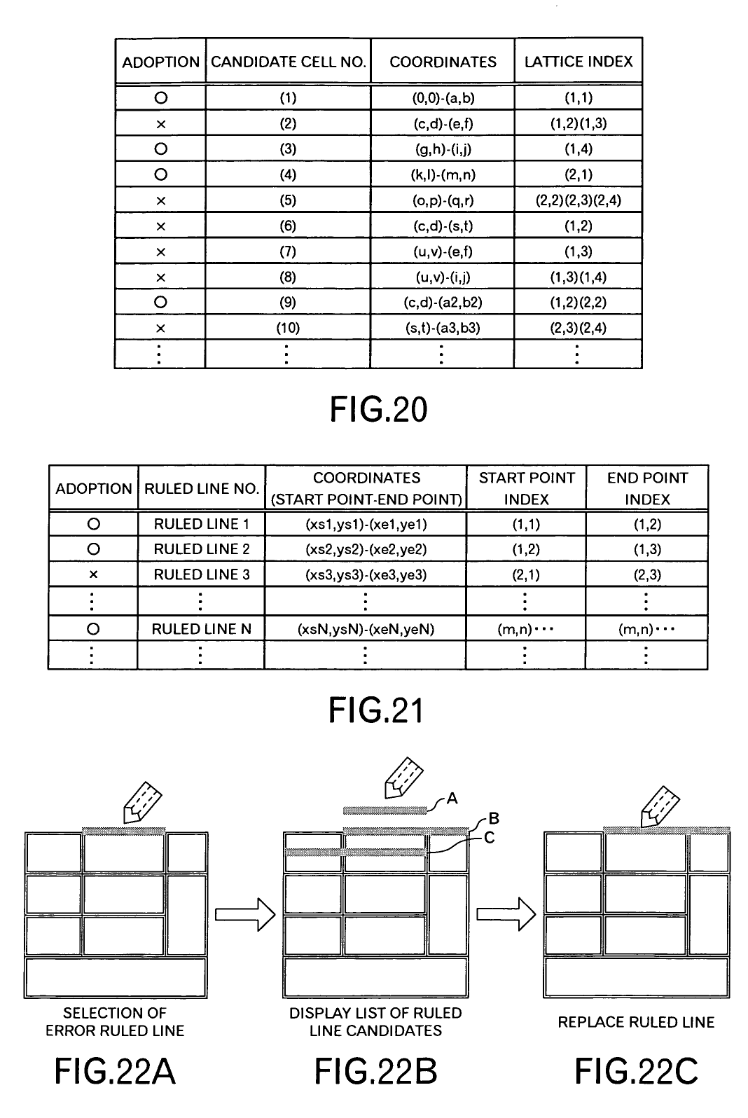

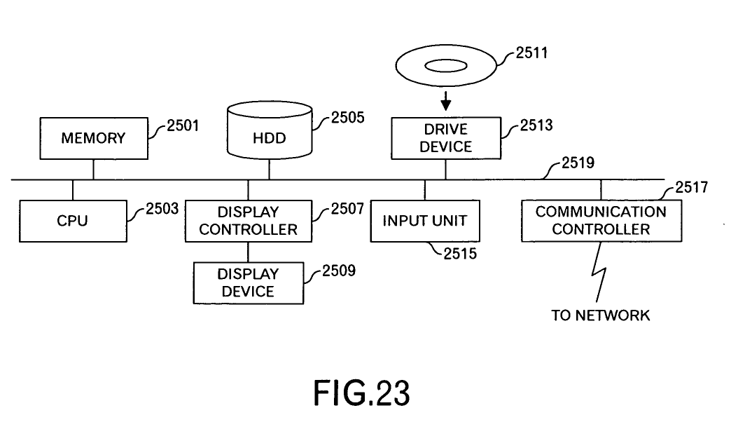

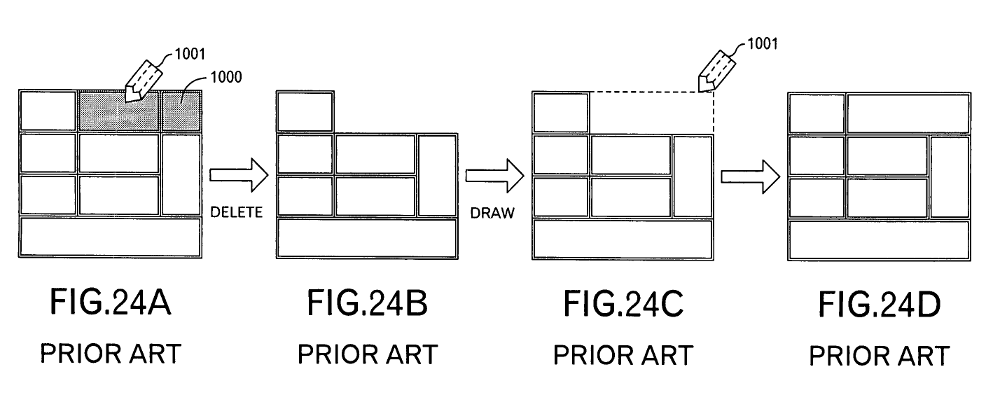

For example, an example when an image including the table as shown in FIG. 7 is processed will be explained. The dotted line indicates an obscure ruled line. In such a case, in the aforementioned processing, the lattice blocks as shown in FIG. 8 (indexes (1,1) to (1,4), and (2,1) to (2,4)) are recognized, and the lattice table as shown in FIG. 9 is generated. The format of the lattice table is the same as FIG. 5. According to the lattice table as shown in FIG. 9, the table recognition result display unit 19 carries out the display as shown in FIG. 10A. However, at this stage, an emphasis display (hatching), which means the error cell, has not been carried out. When the user designates the error cell, the emphasis display is carried out for the error cell, and data of the error cell is outputted to the next candidate generator 91.

When receiving the data of the error cell, the next candidate generator 91 of the candidate generator 9 changes the adoption flag of the error cell to “unadopted” in the lattice table in the lattice data storage 7 (step S23). Incidentally, the candidate cell number (in the example of FIG. 10A, the candidate cell number (2)) of the error cell and the like are held in a main memory, for example. In addition, the next candidate generator 91 identifies the indexes of the lattice blocks constituting the error cell from the lattice table in the lattice data storage 7 (step S25). The data in the column of the lattice index and in the record of the error cell is read out. In the example of FIG. 9, because the error cell is the cell of the candidate cell number (2), the indexes (1,2) and (1,3) are identified.

Next, the next candidate generator 91 selects, as a next candidate cell, candidate cells, respectively including one of lattice blocks constituting the error cell, among unadopted candidate cells except the error cell (step S27). In the example of FIG. 9, because the candidate cells including the index (1,2) or (1,3) of the lattice block is selected, as shown in FIG. 10B, the candidate cell numbers (6), (7), (8) and (9) are selected.

However, when (6) is selected, (7) is automatically selected, and when (7) is selected, (6) is automatically selected. Therefore, (7) may be excluded. That is, when the error cell is composed of two lattice blocks, only either of the lattice blocks may be selected as the next candidate cell. In addition, when the probability of the candidate cell is held, it is possible to exclude the candidate cell whose probability is low, or exclude the candidate cell according to other rules (e.g. a rule to select only either of the candidate cells, which have a complementary relation against the other candidate cell).

Then, the next candidate generator 91 stores data (data of the candidate cell number and the coordinates, and the like) of the next candidate cell into the candidate data storage 13.

The candidate display unit 15 presents the next candidate cells on the display device (step S29). The presentation method of the next candidate cell may be a method of displaying the next candidate cells in a predetermined order as shown in FIGS. 11A and 11B, for example. That is, when an NG button is clicked, the next “next candidate cell” is displayed. When all of the next candidate cells have been presented, the first next candidate cell is displayed. On the other hand, it is possible to adopt a method of presenting all of the next candidate cells in another display column or the like to cause the user to select one of the next candidate cells. At that time, not only the shape of the next candidate cell but also the entire table, which is miniaturized, may be presented. The user selects one he or she think it is appropriate among the displayed next candidate cells.

The candidate selection input unit 17 accepts the selection input of the next candidate cell from the user, and sets “on” to the adoption flag in the lattice table in the lattice data storage 7 based on the candidate cell number of the selected next candidate cell (step S31). Then, the candidate selection input unit 17 instructs the display recognition result display unit 19 to refresh the display based on the data stored in the lattice data storage 7. The display recognition result display unit 19 updates the display by using the data stored in the lattice data storage 7 according to the instruction from the candidate selection input unit 17 (step S33).

By carrying out the aforementioned processing, there is no need to draw the correct cell while paying attention to the coordinates, and the user just needs to select the next candidate cell. That is, he or she can easily correct the error cell, and it is possible to reduce the work load of the user.

Incidentally, as for the step S27, a processing as shown in FIG. 12 is carried out. That is, the next candidate generator 91 identifies an unprocessed and unadopted candidate cell in the lattice table in the lattice data storage 7 (step S41). That is, one candidate cell whose adoption flag is set as “off” is identified. Then, the next candidate generator 91 judges whether or not the identified unadopted candidate cell is composed of the lattice blocks that are completely the same as the lattice blocks, which constitute the error cell and are identified at the step S25 (step S43). That is, because the error cell becomes the unadopted candidate cell, this step is executed not to present the error cell as the next candidate cell at the step S43. When the unadopted candidate cell is composed of the lattice blocks that are completely the same as the lattice blocks constituting the error cell, the processing shifts to step S49.

On the other hand, when the unadopted candidate cell is not composed of the lattice blocks that are completely the same as the lattice blocks constituting the error cell, the next candidate generator 91 judges whether or not the identified unadopted candidate cell includes a lattice block partially covering the error cell (step S45). When the identified unadopted candidate cell does not include the same lattice block as that of the error cell at all, the processing shifts to the step S49 because it is not the candidate cell, which can substitute the error cell. On the other hand, when the identified unadopted candidate cell includes the lattice block partially covering the error cell the next candidate generator 91 identifies the unadopted candidate cell, as the next candidate cell (step S47).

Then, the next candidate generator 91 judges whether or not all of the unadopted candidate cells have been processed (step S49), and when there is an unprocessed unadopted candidate cell, the processing returns to the step S41, and when all of the unadopted candidate cells have been processed, the processing returns to the original processing.

### (2) In Case of the Associated Candidate Generator 93

Next, a processing using the associated candidate generator 93 will be explained by using FIGS. 13 to 16. In the processing of the next candidate generator 91, only one candidate cell can be corrected for the selection of one error cell. However, when one error cell exists, its influence may affect other candidate cells actually. Here, by combining two or more candidate cells, they are simultaneously presented as the associated candidate. The associated candidate satisfies a condition (a) where any candidate cell in the combination is not completely identical with the error cell and the next candidate cell that is a core of the combination, a condition (b) where the candidate cells in the combination have no overlap, and a condition (c) where the combination of the candidate cells and the next candidate cell can cover the error cell.

First, the user watches the initial table displayed on the display device as the recognition result, and confirms whether or not the recognition error exists. Then, when there is the recognition error, the user uses an input device (e.g. mouse or pen) to designate the cell relating to the recognition error. The error cell input unit 11 of the form design support apparatus 100 accepts the selection input of the error cell from the user (step S51), and outputs data of the error cell to the candidate generator 9. Also here, the example of processing the image including the table as shown in FIG. 7 will be explained. Similarly, it is assumed that, in the aforementioned processing, the lattice blocks as shown in FIG. 8 are recognized and the lattice table as shown in FIG. 9 is generated. Then, the table recognition result display unit 19 carries out a display as shown in FIG. 14A. However, at this stage, the emphasis display (hatching), which means the error cell, has not been carried out. When the user designates the error cell, the emphasis display is carried out for the error cell, and data of the error cell is outputted to the associated candidate generator 93.

When receiving the data of the error cell, the associated candidate generator 93 of the candidate generator 9 changes the adoption flag of the error cell to “unadopted” in the lattice table in the lattice data storage 7 (step S53). Incidentally, the candidate cell number (in the example of FIG. 14A, the candidate cell number (2)) of the error cell and the like are held in the main memory, for example. In addition, the associated candidate generator 93 identifies the indexes of the lattice blocks constituting the error cell from the lattice table in the lattice data storage 7 (step S55). The data in the column of the lattice index and in the record of the error cell is read out. In the example of FIG. 9, because the candidate cell number of the error cell is (2), the indexes (1,2) and (1,3) are identified.

Next, the associated candidate generator 93 selects the candidate cell including one of the lattice blocks constituting the error cell among the unadopted candidate cell except the error cell as the next candidate cell (step S57). In the example of FIG. 9, because the candidate cells including the lattice block whose index is (1,2) or (1,3) are selected, the candidate cells (6), (7), (8) and (9) are selected. Incidentally, the processing of FIG. 12 is carried out, specifically.

In addition, the associated candidate generator 93 identifies, for each next candidate cell, the index of the lattice block, which is shared with the error cell (i.e. common to the error cell), and stores it into the storage device such as the main memory (step S59). In the example of FIG. 9, the lattice block (1,2) is identified for the candidate cell (6), the lattice block (1,3) is identified for the candidate cell (7), the lattice block (1,3) is identified for the candidate cell (8), and the lattice block (1,2) is identified for the candidate cell (9).

Furthermore, the associated candidate generator 93 extracts, for each next candidate cell, indexes of the lattice blocks after excluding the lattice blocks identified at the step S59 from the error cell, as remaining lattice blocks, and stores them into the storage device such as the main memory (step S61). The lattice block (1,3) is identified for the candidate cell (6), the lattice block (1,2) is identified for the candidate cell (7), the lattice block (1,2) is identified for the candidate cell (8), and the lattice block (1,3) is identified for the candidate cell (9).

Then, the associated candidate generator 93 identifies, for each next candidate cell, the candidate cell that includes the remaining lattice block and is different from the next candidate cell from the unadopted candidate cell except the error cell, as the associated candidate cell, and registers the combination of the next candidate cell and the associated candidate cell as the associated candidate into the candidate data storage 13 (step S63).

As for the candidate cell (6), the candidate cells (7) and (8) including the lattice block (1,3) are identified. That is, the associated candidate as the combination of the candidate cells (6) and (7) and the associated candidate as the combination of the candidate cells (6) and (8) are constituted, and the candidate cell number, the coordinate data of these cells and the like are stored into the candidate data storage 13.

As for the candidate cell (7), the candidate cells (6) and (9) including the lattice block (1,2) are identified. That is, the associated candidate as the combination of the candidate cells (7) and (6) and the associated candidate as the combination of the candidate cells (7) and (9) are constituted, and the candidate cell number, the coordinate data of these cells and the like are stored in the candidate data storage 13.

As for the candidate cell (8), the candidate cells (6) and (9) including the lattice block (1,2) are identified. That is, the associated candidate as the combination of the candidate cells (8) and (6) and the associated candidate as the combination of the candidate cells (8) and (9) are constituted, and the candidate cell number, the coordinate data of these cells and the like are stored into the candidate data storage 13.

As for the candidate cell (9), the candidate cells (7) and (8) including the lattice block (1,3) are identified. That is, the associated candidate as the combination of the candidate cells (9) and (7) and the associated candidate as the combination of the candidate cells (9) and (8) are constituted, and the candidate cell number, the coordinate data of these cells and the like are stored into the candidate data storage 13.

When these are summarized, as shown in FIG. 14B, 8 associated candidates have been generated. In FIG. 14B, the candidate cell with hatching is the next candidate cell. However, as for the combination of the next candidate cell and the associated candidate cell, as shown in FIG. 14B, because there are duplications, there are substantially only 4 associated candidates.

Shifting to a processing of FIG. 15 via a terminal A, as described above, the associated candidate generator 93 extracts the associated candidates having the same combination of the lattice blocks among the associated candidates, and carries out a processing to merge them if they exist (step S65). Specifically, in the candidate data storage 13, data of one duplicated associated candidate cell is remained, and data of the other duplicated associated candidates is deleted.

Then, the candidate display unit 15 presents the associated candidates on the display device (step S67). The presentation method of the associated candidates may be a method of displaying the associated candidates in a predetermined order as shown in FIGS. 16A and 16B, for example. That is, when the NG button is clicked, the next associated candidate is displayed. When all of the associated candidates have been displayed, the first associated candidate is displayed. On the other hand, it is possible to adopt a method of presenting all of the associated candidates on another display column to cause the user to select one of the associated candidates. At that time, not only the shape of the associated candidate, but also the miniaturized entire table may be presented. The user selects an associated candidate he or she thinks it is appropriate among the displayed associated candidates.

The candidate selection input unit 17 accepts the selection input of the associated candidate from the user, and sets “on” to the adoption flag in the lattice table in the lattice data storage 7 based on the candidate cell number of the selected associated candidate (step S69). Then, the candidate selection input unit 17 instructs the table recognition result display unit 19 to refresh the display based on the data stored in the lattice data storage 7. The table recognition result display unit 19 updates the display by using the data stored in the lattice data storage 7 according to the instruction from the candidate selection input unit 17 (step S71).

By carrying out the aforementioned processing, the user just selects the associated candidate. Because two or more candidate cells can be set, the user's work load is reduced more.

### (3) In Case of the Consecutive Candidate Generator 95

Next, a processing using the consecutive candidate generator 95 will be explained by using FIGS. 17 to 22. In the processing of the next candidate generator 91, only one candidate cell can be corrected for the selection of one error cell. However, when one error cell actually exists, its influence may affect the other candidate cell. Here, by enabling the user to designate the error cell consecutively, the next candidate cell is presented each time the user selects the next candidate cell to improve the usability and the efficiency.

In addition, the user watches the initial table displayed on the display device as the recognition result, and confirms whether or not the recognition error exists. Then, when there is the recognition error, the user uses the input device (e.g. mouse or pen) to designate the cell relating to the recognition error. The error cell input unit 11 of the form design support apparatus 100 accepts the selection input of the error cell from the user (step S81), and outputs data of the error cell to the candidate generator 9. Also here, the example of processing the image including the table as shown in FIG. 9 will be explained. Similarly, it is assumed that, in the aforementioned processing, the lattice blocks as shown in FIG. 8 are recognized, and the lattice table as shown in FIG. 9 is generated. Then, the table recognition result display unit 19 carries out the display as shown in FIG. 18A. However, at this stage, the emphasis display (hatching), which means the error cell, has not been carried out. When the user designates the error cell, the emphasis display is carried out for the error cell, and the data of the error cell is outputted to the consecutive candidate generator 95.

When receiving the data of the error cell, the consecutive generator 95 of the candidate generator 9 changes the adoption flag of the error cell to “unadopted” in the lattice table in the lattice data storage 7 (step S83). Incidentally, the candidate cell number (in the example of FIG. 18A, the candidate cell number (2)) and the like of the error cell are held in the main memory, for example. In addition, the consecutive candidate generator 95 identifies the indexes of the lattice blocks constituting the error cell from the lattice table in the lattice data storage 7 (step S85). The data in the column of the lattice index and in the record of the error cell is read out. In the example of FIG. 9, because the error cell is the cell of the candidate cell number (2), the indexes (1,2) and (1,3) are identified.

Next, the consecutive candidate generator 95 selects, as the next candidate cells, the candidate cells including one of the lattice blocks constituting the error cell among the unadopted candidate cells except the error cell (step S87). In the example of FIG. 9, because the candidate cells including the index (1,2) or (1,3) of the lattice block have to be selected, the candidate cells (6), (7), (8) and (9) are selected. Incidentally, the processing of FIG. 12 is carried out, specifically.

Then, the consecutive candidate generator 95 stores the data (data of the candidate cell number, coordinates and the like) of the next candidate cell into the candidate data storage 13.

The candidate display unit 15 presents the next candidate cell on the display device (step S89). The method of presenting the next candidate cell may be a method of displaying the next candidate cell in a predetermined order as shown in FIGS. 11A and 11B, for example. On the other hand, it is possible to adopt a method to present all of the next candidate cells in another display column to cause the user to select one of the next candidate cells. The user selects one he or she thinks it is appropriate among the displayed next candidate cells.

The candidate selection input unit 17 accepts the selection input of the next candidate cell from the user, and sets “on” to the adoption flag in the lattice table in the lattice data storage 7 from the candidate cell number of the selected next candidate cell (step S91). In addition, the table recognition result display unit 19 updates the display according the lattice table in the lattice data storage 7 according to the instruction from the candidate selection input unit 17 (step S92).

Next, the consecutive candidate generator 95 identifies, from the lattice table, indexes of the lattice blocks constituting the selected next candidate cell (the candidate cell whose adoption flag is set as being “on” this time) according to the update of the lattice data table 7, and stores them into the storage device such as main memory (step S93). When the candidate cell (6) is selected, the lattice block (1,2) is identified. When the candidate cell (7) is selected, the lattice block (1,3) is identified. When the candidate cell (8) is selected, the lattice blocks (1,3) and (1,4) are identified. When the candidate cell (9) is selected, the lattice blocks (1,2) and (1,3) are identified. Here, as shown in FIG. 18B, when it is assumed that the candidate cell (9) is selected, the lattice blocks (1,2) and (2,2) are identified, and stored into the storage device such as the main memory.

Shifting the processing to a processing of FIG. 19 via a terminal B, the consecutive candidate generator 95 extracts the candidate cells including one of the lattice blocks constituting the selected next candidate cell from the adopted candidate cells except the selected next candidate cell in the lattice table in the lattice data storage 7, and stores them into the storage device such as the main memory (step S95). In the example of FIG. 9, the candidate cell (5) is extracted. However, it may not exist according to the case.

Then, the consecutive candidate generator 95 judges whether or not the candidate cell can be extracted at the step S95 (step S97). When it cannot be extracted, the processing shifts to the step S101. On the other hand, when the candidate cell can be extracted, the consecutive candidate generator 95 changes the adoption flag of the extracted candidate cell to “unadopted” in the lattice table (step S99). Here, the cell number of the candidate cell whose adoption flag is changed to “unadopted” is also stored in the storage device such as the main memory. In the above example, “off” is set to the adoption flag of the candidate cell (5). Here, as shown in FIG. 18C, this is a processing to delete the candidate cell duplicated with the next candidate cell, which is newly adopted.

After that, the consecutive candidate generator 95 extracts the indexes of the unadopted lattice blocks from all of the lattice blocks (step S101). At the stage of the step S101, the lattice table is in a state shown in FIG. 20, the lattice blocks of the adopted candidate cells are (1,1), (1,2), (1,4), (2,1) and (2,2), and the unadopted lattice blocks from all of the lattice blocks (1,1) to (1,4) and (2,1) to (2,4) are (1,3), (2,3) and (2,4).

Then, the consecutive candidate generator 95 judges whether or not the unadopted lattice blocks can be extracted at the step S101 (step S103). When there is no unadopted lattice block, the processing returns to the original processing, because all of the lattice blocks are covered by the candidate cells.

On the other hand, when there is at least one unadopted lattice block, the consecutive candidate generator 95 identifies all of the lattice blocks identified at the step S101, as quasi-error cells, and stores them into the storage device such as the main memory (step S105) Then, the processing returns to the step S87 via a terminal C, the processing is carried out while handling the quasi-error cells as the error cell designated by the user. Incidentally, because the error cell designated by the user is never adopted again, it must be excluded from the candidates at the step S87. Furthermore, because it is inappropriate to present the candidate cell set to “unadopted” at the step S99, it must be excluded at the step S87.

In the example of FIG. 20, the portion with the hatching in FIG. 18D is identified as the quasi-error cells. Therefore, at the next step S87, when identifying the unadopted candidate cell including one of (1,3), (2,3) and (2,4), the candidate cells (7), (8) and (10) are identified as the next candidate cells. That is, as shown in FIG. 18E, three types of candidate cells are presented. The presentation method is as described at the step S89.

By carrying out such a processing, it becomes possible to correct another error cell identified by designating the error cell in turn, and the correction work of the user becomes simple and easy. Furthermore, the business efficiency is improved.

Although the correction of the cell in the table was explained above, this embodiment can be applied to the correction of the ruled lines constituting the table. Specifically, the lattice table as shown in FIG. 21 is used. That is, the table includes a column of the adoption flag, a column of the ruled line number, a column of the coordinates (start point and end point), a column of the start point index (identifier of the lattice point), and a column of the end point index. Thus, the ruled lines are identified by using the identifiers (indexes) of the lattice points of the start point and end point, not the indexes of the lattice blocks. Also in the case of the ruled lines, by treating the ruled line between the unit lattice points as the lattice block, the similar processing can be applied.

In addition, also in the case of the ruled line, when the user designates an error ruled line as shown in FIG. 22A, the ruled line candidate is displayed as shown in FIG. 22B. In the example of FIG. 22B, an example where all of the candidates (candidates A to C) are displayed at a time. In the case of the ruled line, because there is a display space, even if all of the candidates are displayed at a time, it does not often become any problem so much. However, the ruled line candidate may be presented one by one. When the user designates the ruled line candidate B, for example, the ruled line is replaced as shown in FIG. 22C.

Although the embodiment of this invention was explained, this invention is not limited to this embodiment. For example, the screen examples are mere examples, and can be changed to various forms. That is, it is possible to display the next candidate by pushing a predetermined key, not using the OK button or NG button, and it is also possible that the next candidate is fixed by an enter key.

In addition, the functional block diagram shown in FIG. 1 is a mere example, and it does not always represent the actual program module configuration.

Incidentally, the form design support apparatus 100 is a computer device as shown in FIG. 23. That is, a memory 2501 (storage device), a CPU 2503 (processor), a hard disk drive (HDD) 2505, a display controller 2507 connected to a display device 2509, a drive device 2513 for a removal disk 2511, an input device 2515, and a communication controller 2517 for connection with a network are connected through a bus 2519 as shown in FIG. 28. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this invention, the application program to realize the aforementioned functions is stored in the removal disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application program are systematically cooperated with each other, so that various functions as described above in details are realized.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. A program embodied on a computer-readable medium, for causing a computer to execute a table data processing, said program comprising:
generating a plurality of candidate cells from an image of a table including a plurality of cells, and outputting an initial table by extracting a specific combination of said candidate cells;
accepting, as designation of an error cell, designation of a specific candidate cell included in said initial table from a user;
generating a candidate group by selecting a candidate cell that can replace at least a portion of the designated error cell, from said candidate cells other than said specific combination of said candidate cells; and
presenting said candidate group for said user, and prompting said user to select one of said candidate cells included in said candidate group.

2. The program as set forth in claim 1, further comprising:
identifying, for each said candidate cell included in said candidate group, an associated candidate cell to be simultaneously selected with said candidate cell included in said candidate group,
wherein said presenting and prompting comprises:
presenting said candidate cell included in said candidate group and said associated candidate cell of said candidate cell.

3. The program as set forth in claim 1, further comprising:
accepting, as selection of a next candidate cell, selection of one said candidate cell included in said candidate group from said user;
identifying a third candidate cell to be selected next to the selected next candidate cell; and
presenting said third candidate cell for said user.

4. The program as set forth in claim 2, wherein said identifying comprises:
identifying, for each said candidate cell included in said candidate group, a non-overlapped portion that is a portion of said error cell, and which said candidate cell included in said candidate group does not cover; and
identifying, for each said candidate cell included in said candidate group, a candidate cell including said non-overlapped portion, other than said specific combination of said candidate cells, as said associated candidate cell.

5. The program as set forth in claim 3, wherein said identifying comprises:
selecting, as a quasi-error cell, a blank in said initial table, which is caused by adopting the selected next candidate cell and excluding said error cell; and
executing said generating said candidate group and subsequent processing by treating said quasi-error cell as said error cell.

6. The program as set forth in claim 1, wherein said table is divided into lattice blocks, each said lattice block being a minimum unit of said candidate cell, and for each of said plurality of candidate cells, identification data of said lattice block constituting said candidate cell, and data representing whether or not said candidate cell is a cell constituting said table are stored in a lattice data storage, and
said generating said candidate group comprises:
identifying said lattice blocks constituting the designated error cell from said lattice data storage; and
referring to said lattice data storage to extract said candidate cell including the identified lattice block from said candidate cells other than said specific combination of said candidate cells.

7. The program as set forth in claim 2, wherein said table is divided into lattice blocks, each said lattice block being a minimum unit of said candidate cell, and for each of said plurality of candidate cells, identification data of said lattice blocks constituting said candidate cell, and data representing whether or not said candidate cell is a cell constituting said table are stored in a lattice data storage, and
said generating said candidate group comprises:
identifying said lattice blocks constituting the designated error cell from said lattice data storage; and
referring to said lattice data storage to extract, as said candidate cell included in said candidate group, said candidate cell including the identified lattice block from said candidate cells other than said specific combination of said candidate cells, and
said identifying said associated candidate cell comprises:
comparing said lattice blocks constituting said candidate cell, which are identified from said lattice data storage, with said lattice blocks constituting said error cell to identify, for each said candidate cell included in said candidate group, a non-overlapped lattice block that is said lattice block included in said error cell, and which said candidate cell included in said candidate group does not cover; and
identifying, for each said candidate cell included in said candidate group, said candidate cell including said non-overlapped lattice block other than said specific combination of said candidate cells from said lattice data storage, as said associated candidate cell.

8. The program as set forth in claim 3, wherein said table is divided into lattice blocks, each said lattice block being a minimum unit of said candidate cell, and for each of said plurality of candidate cells, identification data of said lattice blocks constituting said candidate cell, and data representing whether or not said candidate cell is a cell constituting said table are stored in a lattice data storage, and
said generating said candidate group comprises:
registering data so as to exclude the designated error cell from said cells constituting said table, for the designated error cell in said lattice data storage;
identifying, from said lattice data storage, said lattice blocks constituting the designated error cell; and
extracting, as said candidate cell included in said candidate group, said candidate cell including the identified lattice block from said candidate cells that are registered in said lattice data storage as not being said cells constituting said table, except said error cell, and
said identifying the third candidate cell comprises:
registering, as said cell constituting said table, the selected next candidate cell in said lattice data storage;
identifying said candidate cell including said lattice block constituting said error cell among said candidate cells that are registered as said cells constituting said table in said lattice data storage, except the selected next candidate cell, and registering data so as to exclude the identified candidate cell from said cells constituting said table;
identifying, as said quasi-error cell, said lattice block that is not adopted for any of said candidate cells registered as said cells constituting said table in said lattice data storage; and
executing said generating said candidate group and subsequent processing by treating said quasi-error cell as said error cell.

9. A program embodied on a computer-readable medium, for causing a computer to execute a table data processing, said program comprising:
generating a plurality of candidate ruled lines from an image of a table including a plurality of ruled lines, and outputting an initial table by extracting a specific combination of said candidate ruled lines;
accepting, as designation of an error ruled line, designation of a specific candidate ruled line included in said initial table from a user;
generating a candidate group by selecting a candidate ruled line that can replace at least a portion of the designated error ruled line, from said candidate ruled lines other than said specific combination of said candidate ruled lines; and
presenting said candidate group for said user, and prompting said user to select one of said candidate ruled lines included in said candidate group.

10. The program as set forth in claim 9, further comprising:
identifying, for each said candidate ruled line included in said candidate group, an associated candidate ruled line to be simultaneously selected with said candidate ruled line included in said candidate group,
wherein said presenting and prompting comprises:
presenting said candidate ruled line included in said candidate group and said associated candidate ruled line of said candidate ruled line.

11. The program as set forth in claim 9, further comprising:
accepting, as selection of a next candidate ruled line, selection of one said candidate ruled line included in said candidate group from said user;
identifying a third candidate ruled line to be selected next to the selected next candidate ruled line; and
presenting said third candidate ruled line for said user.

12. A table data processing method, comprising:
generating a plurality of candidate cells from an image of a table including a plurality of cells, and outputting an initial table by extracting a specific combination of said candidate cells;
accepting, as designation of an error cell, designation of a specific candidate cell included in said initial table from a user;
generating a candidate group by selecting a candidate cell that can replace at least a portion of the designated error cell, from said candidate cells other than said specific combination of said candidate cells; and
presenting said candidate group for said user, and prompting said user to select one of said candidate cells included in said candidate group.

13. The table data processing method as set forth in claim 12, further comprising:
identifying, for each said candidate cell included in said candidate group, an associated candidate cell to be simultaneously selected with said candidate cell included in said candidate group,
wherein said presenting and prompting comprises:
presenting said candidate cell included in said candidate group and said associated candidate cell of said candidate cell.

14. The table data processing method as set forth in claim 12, further comprising:
accepting, as selection of a next candidate cell, selection of one said candidate cell included in said candidate group from said user;
identifying a third candidate cell to be selected next to the selected next candidate cell; and
presenting said third candidate cell for said user.

15. A table data processing method, comprising:
generating a plurality of candidate ruled lines from an image of a table including a plurality of ruled lines, and outputting an initial table by extracting a specific combination of said candidate ruled lines;
accepting, as designation of an error ruled line, designation of a specific candidate ruled line included in said initial table from a user;
generating a candidate group by selecting a candidate ruled line that can replace at least a portion of the designated error ruled line, from said candidate ruled lines other than said specific combination of said candidate ruled lines; and
presenting said candidate group for said user, and prompting said user to select one of said candidate ruled lines included in said candidate group.

16. A table data processing apparatus, comprising:
a unit that generates a plurality of candidate cells from an image of a table including a plurality of cells, and outputs an initial table by extracting a specific combination of said candidate cells;
a unit that accepts, as designation of an error cell, designation of a specific candidate cell included in said initial table from a user;
a unit that generates a candidate group by selecting a candidate cell that can replace at least a portion of the designated error cell, from said candidate cells other than said specific combination of said candidate cells; and
an output unit that presents said candidate group for said user, and prompting said user to select one of said candidate cells included in said candidate group.

17. The table data processing apparatus as set forth in claim 16, further comprising:
a unit that identifying, for each said candidate cell included in said candidate group, an associated candidate cell to be simultaneously selected with said candidate cell included in said candidate group,
wherein said output unit comprises:
a unit that presents said candidate cell included in said candidate group and said associated candidate cell of said candidate cell.

18. The table data processing apparatus as set forth in claim 16, further comprising:
a unit that accepts, as selection of a next candidate cell, selection of one said candidate cell included in said candidate group from said user;
a unit that identifies a third candidate cell to be selected next to the selected next candidate cell; and
a unit that presents said third candidate cell for said user.

19. A table data processing apparatus, comprising:
a unit that generates a plurality of candidate ruled lines from an image of a table including a plurality of ruled lines, and outputs an initial table by extracting a specific combination of said candidate ruled lines;
a unit that accepts, as designation of an error ruled line, designation of a specific candidate ruled line included in said initial table from a user;
a unit that generates a candidate group by selecting a candidate ruled line that can replace at least a portion of the designated error ruled line, from said candidate ruled lines other than said specific combination of said candidate ruled lines; and
a unit that presents said candidate group for said user, and prompting said user to select one of said candidate ruled lines included in said candidate group.
